(19) United States
(12) Patent Application Publication
(10) Pub. No.: US 2025/0373910 A1
(43) Pub. Date: Dec. 4, 2025

(54) VIDEO PROCESSING METHOD AND APPARATUS, ELECTRONIC DEVICE AND STORAGE MEDIUM

(71) Applicant: Beijing Zitiao Network Technology Co., Ltd., Haidian District (CN)

(72) Inventors: Zhaoyi LIU, Beijing (CN); Shichen PENG, Beijing (CN); Yue LI, Beijing (CN)

(21) Appl. No.: 19/218,899

(22) Filed: May 27, 2025

(30) Foreign Application Priority Data
May 30, 2024 (CN) 202410692445.4

(51) Int. Cl. H04N 21/81; H04N 21/44; H04N 21/472

(52) U.S. Cl. CPC H04N 21/816; H04N 21/44016; H04N 21/47217

(57) ABSTRACT

A video processing method and apparatus, an electronic device and a storage medium. The video processing method, including: in response to a template editing operation input for a video template, displaying a plurality of slots corresponding to the video template, the slots corresponding to a first material used for making the video template; in response to a material addition operation input for the slots, adding a second material into a triggered first slot among the plurality of slots; and in response to a video generation operation, when the plurality of slots include a second slot not filled with the second material, adding a third material into the second slot, and generating a target video based on the second material, the third material and the video template.

### CROSS-REFERENCE TO RELATED APPLICATION(S)

The present application claims the priority of the Chinese patent application 202410692445.4 filed on May 30, 2024, the entire contents of which are hereby incorporated by reference as a part of the present application.

### TECHNICAL FIELD

Embodiments of the present disclosure relate to computer application technology, in particular to a video processing method and apparatus, an electronic device and a storage medium.

### BACKGROUND

In the scenarios of image processing or video production, an increasing number of users are adopting video templates to create videos, in order to enrich the display effect of the videos. For example, users may replace the images and/or videos in a video template with their chosen images and/or videos.

In the related art, when creating a target video based on video templates, different video templates have varying requirements for the materials chosen by the user. This leads to certain limitations in the selection process for materials or video templates, resulting in a high barrier to using video templates, which negatively impacts the user experience.

### SUMMARY

The present disclosure provides a video processing method and apparatus, an electronic device, a storage medium and a program product.

An embodiment of the present disclosure provides a video processing method, including:
in response to a template editing operation input for a video template, displaying a plurality of slots corresponding to the video template, the slots corresponding to a first material used for making the video template;
in response to a material addition operation input for the slots, adding a second material into a triggered first slot among the plurality of slots; and
in response to a video generation operation, when the plurality of slots include a second slot not filled with the second material, adding a third material into the second slot, and generating a target video based on the second material, the third material and the video template.

An embodiment of the present disclosure provides a video processing apparatus, including:
a slot display module configured to, in response to a template editing operation input for a video template, display a plurality of slots corresponding to the video template, the slots corresponding to a first material used for making the video template;
a material addition module configured to, in response to a material addition operation input for the slots, add a second material into a triggered first slot among the plurality of slots; and
a video generation module configured to, in response to a video generation operation, when the plurality of slots include a second slot not filled with the second material, add a third material into the second slot, and generate a target video based on the second material, the third material and the video template.

An embodiment of the present disclosure provides an electronic device, including: one or more processors; and
a storage apparatus configured to store one or more programs,
where the one or more programs, when executed by the one or more processors, cause the one or more processors to implement the video processing method as described in any of the embodiments of the present disclosure.

An embodiment of the present disclosure provides a storage medium containing computer-executable instructions, where the computer-executable instructions, when executed by a computer processor, implement the video processing method as described in any of the embodiments of the present disclosure.

An embodiment of the present disclosure provides a computer program product, including computer programs which, when executed by a processor, implement the video processing method as described in any of the embodiments of the present disclosure.

### BRIEF DESCRIPTION OF DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale.

FIG. 1 is a flow diagram of a video processing method according to an embodiment of the present disclosure;

FIG. 2 is a schematic effect diagram of a video processing page according to an embodiment of the present disclosure;

FIG. 3 is another schematic effect diagram of a video processing page according to an embodiment of the present disclosure;

FIG. 4 is a flow diagram of another video processing method according to an embodiment of the present disclosure;

FIG. 5 is a flow diagram of another video processing method according to an embodiment of the present disclosure;

FIG. 6 is a flow diagram of another video processing method according to an embodiment of the present disclosure;

FIG. 7 is a schematic diagram of a video processing apparatus according to an embodiment of the present disclosure; and

FIG. 8 is a schematic diagram of an electronic device according to an embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as being limited to the embodiments set forth herein. Rather, these embodiments are provided for a thorough and complete understanding of the present disclosure. It should be understood that the drawings and embodiments of the present disclosure are only for exemplary purposes, and are not intended to limit the scope of the present disclosure.

It should be understood that various steps described in method implementations of the present disclosure can be performed in different orders, and/or performed in parallel. In addition, the method implementations can include additional steps and/or omit performing the illustrated steps. The scope of the present disclosure is not limited in this respect.

The term “include/comprise” used herein and the variations thereof are open-ended inclusions, namely, “include/comprise but not limited to”. The term “based on” is “at least partially based on”. The term “one embodiment” means “at least one embodiment”; the term “another embodiment” means “at least one other embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules, or units, and are not used to limit the order of functions performed by these apparatuses, modules, or units or interdependence between these apparatuses, modules, or units.

It should be noted that the modifications of “one” and “a plurality” mentioned in the present disclosure are illustrative rather than restrictive, and those skilled in the art should understand that unless the context clearly indicates otherwise, the modifications should be understood as “one or more”.

The names of messages or information exchanged between a plurality of apparatuses in the implementations of the present disclosure are only for illustrative purposes, and are not intended to limit the scope of these messages or information.

It should be understood that before using the technical solutions disclosed in the embodiments of the present disclosure, the user should be informed of the type, scope of use, use scenario, etc. of the personal information involved in the present disclosure in accordance with relevant laws and regulations in an appropriate manner, and the user's authorization should be obtained.

For example, in response to receiving a proactively request from a user, prompting information is sent to the user to explicitly prompt the user that the requested operation will require access to and use of the user's personal information. Thereby, the user is enabled to independently choose whether or not to provide the personal information to software or hardware, such as an electronic device, an application, a server, or a storage medium, that performs the operation of the technical solution of the present disclosure based on the prompting information.

As an optional but non-limiting realization, in response to receiving a proactively request from the user, the manner of sending the prompting information to the user may be, for example, a pop-up window, in which the prompting information may be presented in the form of text. In addition, the pop-up window may contain an option control for the user to select “agree” or “disagree” to provide the personal information to the electronic device.

It should be understood that the above notification and user authorization process is only schematic, and does not limit the implementation of the present disclosure, and other ways to meet the relevant laws and regulations may also be applied to the implementation of the present disclosure.

It is understood that the data involved in the present technical solution (including but not limited to the data itself, the acquisition or use of the data) should comply with the requirements of the corresponding laws and regulations and relevant provisions.

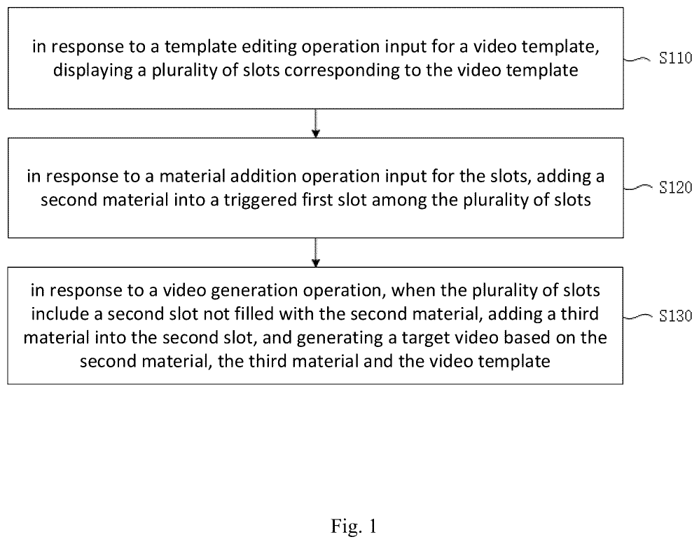

FIG. 1 is a flow diagram of a video processing method according to an embodiment of the present disclosure. The embodiments of the present disclosure are applicable to scenarios where target videos are produced based on video templates. The method may be implemented by a video processing apparatus. The apparatus may be realized by software and/or hardware, or alternatively, by an electronic device, which may be a mobile terminal, a PC terminal or a server.

As shown in FIG. 1, the method provided by the embodiment may include the following steps.

S110, in response to a template editing operation input for a video template, displaying a plurality of slots corresponding to the video template.

The video template may be understood as a fixed-format video processing template which serves as a reference guide during the process of making materials into a video. In the embodiments of the present disclosure, when creating a video template, at least one material may be determined along with associated content applicable to each material. Subsequently, a video template may be generated based on the at least one material and the corresponding associated content. The material used during the creation of the video template may be taken as a first material. The first material may be any type of media content which can be displayed on an interface, such as images, videos, and documents. The video template may include the first material and associated content applicable to the first material. Generally, users may generate a target video that meets their production needs by replacing the first material in the video template with user-selected materials to be processed. The template editing operation may be understood as an action that puts the video template into an editable state. It should be noted that the template editing operation may be preset to allow editing of the video template. Further, upon detecting a template editing operation for the video template, a plurality of slots corresponding to the video template may be displayed in response to the triggered template editing operation. Alternatively, the template editing operation may include at least one of the following: triggering a template editing control; receiving a template editing instruction; etc. For example, the template editing control may be preset, and upon detecting a selection trigger operation on the video template, a page including the template editing control may be displayed. Further, when a trigger operation on the template editing control is detected, it can be determined that a template editing operation on the video template has been detected, and in response to the template editing operation, a plurality of slots corresponding to the video template may be displayed.

The slots correspond to the first material used in creating the video template. The slots corresponding to the video template may be understood as data space generated based on the first material added during the creation of the video template and can be used to add customized materials (which can be the first material or other materials). The slots specifically indicate the type of materials that can be added, as well as the display position (order of display) and display time (including display duration and/or start and end times) of the materials that can be added in a target video to be generated. The main difference between the display information of the customized materials added in the slots in the target video and the display information of the first material in the video template is the difference in the content of the materials, and the display duration and display order of are the same. By adding customized materials in the slots to replace the first material (sample material) in the video template, the target video can be generated quickly and easily.

In the embodiments of the present disclosure, upon detecting a template editing operation input for the video template, template production information corresponding to the video template (including the number of first materials, material types, and display information in the video template) may be determined. Subsequently, a plurality of slots corresponding to the video template may be displayed based on the template production information.

As an alternative implementation of the embodiments of the present disclosure, when a template editing operation input for the video template is detected, in response to the template editing operation, a video processing page is displayed, where a plurality of slots corresponding to the video template is display in the video processing page.

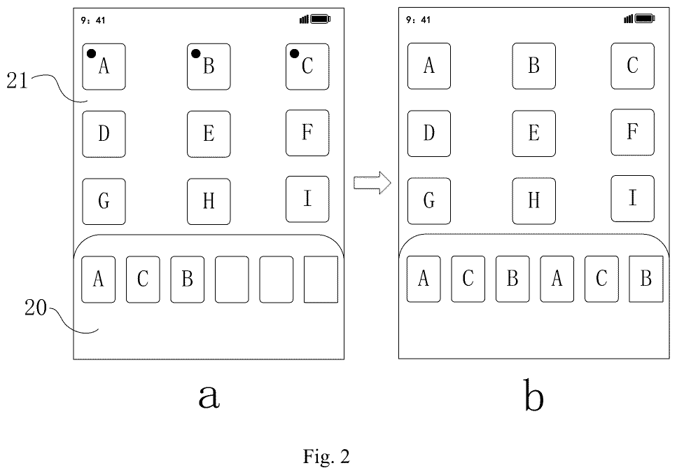

The video processing page may be understood as a visual editing page which supports video production. It should be noted that the video processing page may also display at least one candidate material to be added into the slots. Alternatively, the plurality of slots corresponding to the video template may be displayed using a dropdown display panel, and at least one candidate material may be shown on a material display page located on the layer below the display panel. In other words, the display panel for displaying the plurality of slots may overlay the material display page for displaying the at least one candidate material. For example, FIG. 2 is a schematic effect diagram of a video processing page according to an embodiment of the present disclosure. As shown in part (a) of FIG. 2, the video processing page includes a slot display panel 20 and a material display page 21. There may be 6 slots corresponding to the video template, namely Slot 1, Slot 2, Slot 3, Slot 4, Slot 5, and Slot 6. There may be 9 candidate materials to be added into the slots, namely Candidate Material A, Candidate Material B, Candidate Material C, Candidate Material D, Candidate Material E, Candidate Material F, Candidate Material G, Candidate Material H, and Candidate Material I.

S120, in response to a material addition operation input for the slots, adding a second material into a triggered first slot among the plurality of slots.

The material addition operation may be understood as an action of adding customized materials to corresponding slots. In the embodiments of the present disclosure, the material addition operation input for the slots may be implemented in various ways. Alternatively, a slot selection trigger operation may be input for the slot, updating the slot to a selected state. Further, a material selection trigger operation may be input for the candidate material. Consequently, it can be determined that a material addition operation input for the slot has been detected. At this point, a slot corresponding to the slot selection trigger operation may be considered as the triggered first slot. Alternatively, in response to detecting that a second material has been added into the slot preceding the current slot according to a preset arrangement order, it can be determined that a material addition operation input for the current slot has been detected. In this case, the current slot may be used as the triggered first slot. In the embodiments of the present disclosure, the first slot may be understood as the slot where the second material is added. The second material may be understood as the customized material added into the slot based on the material addition operation input by users. The second material may be any type of media content which can be displayed on the interface, such as images, videos, and documents. The second material may be obtained from a target storage space (e.g., an image library of an application or a photo album of a terminal) in response to a trigger operation by users, or the second material may be received from an external device.

As an alternative implementation of the embodiments of the present disclosure, the second materials may be sequentially added into the triggered first slots based on the selection order of the candidate materials. Further, in response to detecting that a second material has been added into the slot preceding the current slot according to a preset arrangement order, it can be determined that a material addition operation input for the current slot has been detected. Subsequently, the current slot is used as the triggered first slot. Additionally, in response to detecting a selection trigger operation on any material, the material may be considered as the second material and added into the first slot.

As another alternative implementation of the embodiments of the present disclosure, in response to detecting a selection trigger operation on any of the plurality of displayed slots, the slot may be used as the triggered first slot. Additionally, in response to detecting a selection trigger operation on any material, the material may be considered as the second material and added into the first slot.

For example, continuing to refer to part (a) of FIG. 2, when all six slots displayed in the video processing page is blank, in response to detecting a selection trigger operation on Candidate Material A, Candidate Material A is updated to the selected state and added into Slot 1. Further, in response to detecting a selection trigger operation on Candidate Material C, Candidate Material C is updated to the selected state and added into Slot 2. In response to detecting a selection trigger operation on Candidate Material B, Candidate Material B is updated to the selected state and added into Slot 3.

S130, in response to a video generation operation, when the plurality of slots include a second slot not filled with the second material, adding a third material into the second slot, and generating a target video based on the second material, the third material and the video template.

Here, the video generation operation may be understood as an operation of generating a target video based on edited materials and a video template according to preset video generation logic. Alternatively, the video generation operation may be implemented in at least one of the following methods: triggering a video generation control; receiving a video generation instruction; triggering the video generation operation upon detecting that a second material is added into the last slot among a plurality of slots; or triggering the video generation operation upon detecting that each slot among the plurality of slots has added a second material, among others. The second slot may be understood as a slot among the plurality of slots not filled with a second material when the video generation operation is detected; alternatively, the second slot may be understood as a blank slot among the plurality of slots when the video generation operation is detected. In the embodiments of the present disclosure, when the video generation operation is not input, any editing may be performed on the plurality of displayed slots. At this point, the slot where the material addition operation is detected may be regarded as the triggered first slot, and the second material may be added into the first slot. Further, a material deletion operation may be input for the first slot to remove the second material added into the first slot, making it no longer the first slot but rather a blank slot not filled with a second material. This means that before the video generation operation is input, the first slot among the plurality of slots may change at any time, and the second slot not filled with a second material is uncertain. Consequently, upon detecting the video generation operation, the slot among the plurality of slots not filled with a second material at this point may be regarded as the second slot.

In the embodiments of the present disclosure, the third material may be understood as a material added into the second slot. Alternatively, the third material may be a preset sample material; or the third material may be a material determined based on the second material added into the first slot; or the third material may be a material determined by other means.

As an alternative implementation of the embodiments of the present disclosure, adding a third material into the second slot includes: determining the number of second slots among the plurality of slots not filled with a second material; retrieving sample materials based on the number of second slots, using the retrieved sample materials as the third materials, and sequentially adding the third materials to the second slots. Alternatively, a method of retrieving the sample materials may include random retrieval, retrieval based on the type of the second material, or retrieval based on a subject type of a target material subject included in the second material, among others.

As an alternative implementation of the embodiments of the present disclosure, adding a third material into the second slot includes: determining the third material to be added into the second slot based on the second material added into the first slot, and then adding the third material into the second slot. For example, the second materials added into the first slots may be used as the third materials, which are then added sequentially into the second slots. Still referring to part (a) and part (b) of FIG. 2, in response to Candidate Material A being added into Slot 1, Candidate Material C to Slot 2, and Candidate Material B to Slot 3, Slots 4, 5, and 6 are considered to be the second slots. At this point, Candidate Material A, Candidate Material C, and Candidate Material B are added into Slot 4, Slot 5, and Slot 6 in sequence, in the order of adding materials in the slots, as shown in part (b) of FIG. 2.

In the embodiments of the present disclosure, after adding the third material into the second slot, a target video may be generated based on the second material, the third material, and the video template. The target video may be understood as a video which displays the second material and the third material according to a template format of the video template. The target video may be produced by editing corresponding materials based on material editing information associated with each slot in the video template (for example, animation effects, transition effects, music, or sound effects added to the materials).

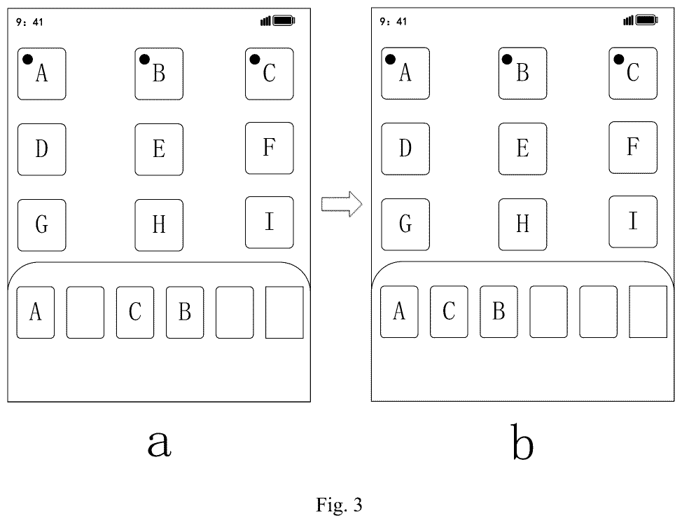

It should be noted that during the process of inputting a material editing operation on the slots, there may be instances where a material deletion operation is input for the first slot already filled with a second material, in order to remove the second material from the slot. Alternatively, during the process of inputting a material addition operation for the slots, the implementation method of the material addition operation may involve a situation where the selected first slots are not continuously arranged among the plurality of slots when a selection trigger operation is input for the slots. Consequently, in response to the video generation operation, there may be cases where at least two first slots among the plurality of first slots are not continuously arranged, meaning that at least one second slot exists between at least two first slots. For example, FIG. 3 is another schematic effect diagram of a video processing page according to an embodiment of the present disclosure. As shown in part (a) of FIG. 3, assuming there are 3 first slots, designated as Slot 1, Slot 3, and Slot 4, the second material added in Slot 1 is Candidate Material A, the second material added in Slot 3 is Candidate Material C, the second material added in Slot 4 is Candidate Material B, and it can be seen that Slot 1 and Slot 3 are not continuously arranged.

In view of this, in the embodiments of the present disclosure, after responding to a video generation operation and before adding a third material into the second slot, the video processing method further includes: when a plurality of first slots being provided and at least two of the first slots being not continuously arranged, adjusting addition positions of the second materials already added into at least one of the first slots in the plurality of slots, to ensure that the plurality of first slots after adjustment are continuously arranged.

In the embodiments of the present disclosure, adjusting addition positions of the second materials already added into at least one of the first slots in the plurality of slots may be implemented in various ways, which will be explained separately below.

First approach: the second material added to the last of the at least one first slot may be moved to the second slot situated between at least two first slots which are not continuously arranged, ensuring that the resulting multiple first slots are continuous in their positions after adjustment. For example, still referring to the previous example, assuming there are 3 first slots, namely Slot 1, Slot 3, and Slot 4, the second material added to Slot 1 is Candidate Material A, the second material added to Slot 3 is Candidate Material C, the second material added to Slot 4 is Candidate Material B, and it can be seen that Slot 1 and Slot 3 are not continuously arranged. Further, the addition position of Candidate Material B added in Slot 4 may be adjusted to Slot 2. Thus, 3 first slots with continuous arrangement positions may be obtained, which are Slot 1 with Candidate Material A, Slot 2 with Candidate Material B, and Slot 3 with Candidate Material C.

Second approach: the added second materials may be moved in a predetermined manner among the plurality of slots, so that the resulting multiple first slots are arranged continuously. The predetermined manner may include moving the added second materials in the plurality of slots in a preset movement direction. Alternatively, moving in the preset movement direction may include moving toward the first one of the plurality of slots, or moving toward the last slot among the plurality of slots, etc. For example, as shown in part (a) of FIG. 3, the arrangement positions of Slot 1 and Slot 3 are not continuous. Candidate Material C and Candidate Material B may be moved toward Slot 1, resulting in Candidate Material C being moved to Slot 2 and Candidate Material B being moved to Slot 3. Consequently, this results in 3 first slots with a continuous arrangement, that is, Slot 1 with Candidate Material A, Slot 2 with Candidate Material C, and Slot 3 with Candidate Material B, as shown in part (b) of FIG. 3.

It should be noted that the benefit of adjusting addition positions of the second materials already added into at least one of the first slots in the plurality of slots based on the aforementioned methods is that it achieves automatic adjustment of material filling positions, resulting in a continuous arrangement of the adjusted first slots, thereby enhancing the display effect of the target video.

It should also be noted that each slot included in the video template has corresponding slot association information, which may include information such as slot duration, slot position, and material effect. The second material added into the first slot also has its own corresponding material association information, which may include information such as material type and material duration. in the case where the slot has a corresponding slot duration and the second material has a corresponding material duration, there may be situations where the material duration of the second material is shorter than, equal to, or longer than the slot duration of the first slot. In practical applications, when adding materials to the slots to create a target video, the slot duration of the slot for the material to be added is usually determined first. Subsequently, candidate materials are filtered based on the slot duration, excluding those with a material duration shorter than the slot duration, and selecting from the candidate materials which have a material duration equal to or longer than the slot duration. When making videos based on the above methods, due to the limitations imposed by the template usage, the video production process may be somewhat constrained, affecting the user experience with the video template.

In view of this, in the embodiments of the present disclosure, a material duration of the second material is shorter than a slot duration of the first slot; and after generating a target video based on the second material, the third material and the video template, the video processing method further includes: during the playback of the target video, for the second material with a material duration shorter than a slot duration of the corresponding first slot, controlling the second material to play in a loop such that a display duration of the second material reaches the slot duration.

Here, the slot duration may be understood as the length of time allowed for the materials added to the slot to be displayed in the video. The display duration of the second material may refer to the length of time that the second material is displayed in the target video.

As an alternative implementation of the embodiments of the present disclosure, during the playback of the target video, upon detecting that the material duration of the second material is shorter than the slot duration of the corresponding first slot, the second material may be controlled to play in a loop based on predetermined playback control logic, ensuring that the display duration of the second material reaches the slot duration of the corresponding first slot. The predetermined playback control logic may include restarting the playback from the first frame of the second material upon detecting that the last frame of the second material is reached and the corresponding slot duration has not yet been fulfilled. The benefit of this setup is that it eliminates the limitation of material duration during the material selection process, allowing the generation of the target video even when the material duration is shorter than the slot duration. Further, it enhances the flexibility and intelligence of the video production process, improving the user experience with the video template.

The technical scheme of the embodiments of the present disclosure simplifies the process of editing video templates by responding to a template editing operation input for a video template and displaying a plurality of slots corresponding to the video template. Further, in response to a material addition operation input for the slots, a second material is added into a triggered first slot among the plurality of slots, achieving simple replacement of a first material in the video template and enabling easy addition of the customized second material to the video template. Further, in response to a video generation operation, when the plurality of slots include a second slot not filled with the second material, a third material is added into the second slot, and a target video is generated based on the second material, the third material, and the video template. This solves the problem of certain limitations in the selection process of video templates during video production in related arts, resulting in a high threshold for the use of video templates. It also enables automatic material filling of unfilled slots in the video template, resulting in the production of a target video based on the video template and the materials already added thereto, thereby reducing the restrictions on the use of video templates. Further, it enhances the flexibility of the video production process, allowing the generated target video to more completely present an effect similar to that of the video template, thereby improving the user experience with the video templates.

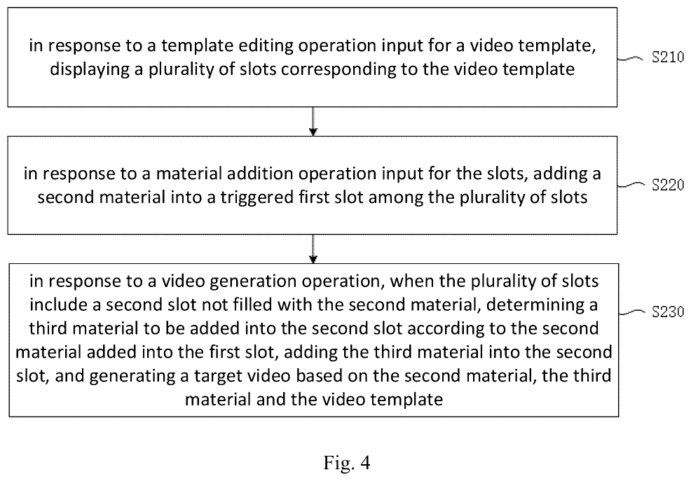

FIG. 4 is a flow diagram of another video processing method according to an embodiment of the present disclosure. In the technical scheme of this embodiment, on the basis of the above embodiment, adding a third material into the second slot includes: determining a third material to be added into the second slot according to the second material added into the first slot, and adding the third material into the second slot. Detailed implementation can be found in the description of this embodiment. The same or similar technical features as those in the previous embodiments are not repeated here.

As shown in FIG. 4, the method provided by this embodiment may include the following steps.

S210, in response to a template editing operation input for a video template, displaying a plurality of slots corresponding to the video template.

S220, in response to a material addition operation input for the slots, adding a second material into a triggered first slot among the plurality of slots.

S230, in response to a video generation operation, when the plurality of slots include a second slot not filled with the second material, determining a third material to be added into the second slot according to the second material added into the first slot, adding the third material into the second slot, and generating a target video based on the second material, the third material and the video template.

In the embodiments of the present disclosure, determining a third material to be added into the second slot according to the second material added into the first slot may be implemented in various ways, which will be explained separately below.

First approach: Any one or more of the second materials added into the first slot may be selected as the third material and randomly added into the second slot.

Second approach: For each second slot, a first slot with the closest arrangement distance to the second slot may be determined among the plurality of slots, and the second material added in the first slot are used as the third material to be added into the second slot.

Third approach: Based on the arrangement positions of the first slots and the second slots among the plurality of slots, as well as the second material added in the first slot, the third material to be added into each second slot is determined.

Here, the arrangement position may be understood as the position of the first or second slot among the plurality of slots.

In the embodiments of the present disclosure, the first slots and the second slots may be treated as two independent slot sets. Further, the relative arrangement positions of each first slot among the plurality of first slots are defined as first arrangement positions, while the relative arrangement positions of each second slot among the plurality of second slots are defined as second arrangement positions. Additionally, when the first arrangement position and the second arrangement position are the same, the second material added in the first slot corresponding to the first arrangement position may be used as the third material to be added into the second slot corresponding to the second arrangement position. The benefit of this setup is that it allows for filling the second slots based on the second materials added in the first slots, while maximizing the retention of the original video effect of the video template. This ultimately enhances the flexibility of the video production process and improves the display effect of the target video.

As an example, when the number of first slots is 3, the first arrangement positions include a first one, a second one, and a third one. When the number of second slots is 3, the second arrangement positions include a first one, a second one, and a third one. Further, the second material added into the first one of the first slots may be taken as the third material to be added into the first one of the second slots, the second material added into the second one of the first slots may be taken as the third material to be added into the second one of the second slots, and the second material added into the third one of the first slots may be taken as the third material to be added into the third one of the second slots.

In the embodiments of the present disclosure, when the number of second slots is greater than the number of first slots, the second slots may be divided into multiple slot groups based on the number of first slots, with each slot group containing at most the same number of slots as the first slots. Further, the relative arrangement positions of each first slot among the plurality of first slots may be considered first arrangement positions. With respect to each slot group, the relative arrangement positions of the second slots within its corresponding slot group may be referred to as second arrangement positions. Additionally, when the first arrangement position and the second arrangement position in each slot group are the same, the second material added into the first slots corresponding to the first arrangement position may be used as the third material to be added into the second slot corresponding to the second arrangement position in each slot group.

As an example, assuming there are 3 first slots and 5 second slots, the second slots may be divided into two groups based on the number of first slots. The first slot group may include 3 second slots, while the second slot group may include 2 second slots. The first arrangement positions may include a first one, a second one, and a third one; the second relative positions in the first slot group may include a first one, a second one, and a third one; and the second relative positions in the second slot group may include a first one and a second one. Further, the second material added in the first one of the first slots may be used as the third material to be added into the first one of the second slots in the first slot group and the first one of the second slots in the second slot group, the second material added in the second one of the first slots is used as the third material to be added into the second one of the second slots in the first slot group and the second one of the second slots in the second slot group, and the second material added to the third one of the first slots is used as the third material to be added into the third one of the second slots in the first slot group.

It should be noted that the aforementioned method involves grouping the plurality of slots based on the first slots and the second slots in the plurality of slots, treating the first slots and the second slots as two independent slot sets, to ensure that the slot sets include only first slots or only second slots. Therefore, whether there are multiple first slots with at least two discontinuous arrangement positions or continuous arrangement positions among the multiple first slots, the above method can be used to determine the third materials to be added into the second slots.

In the embodiments of the present disclosure, after determining a third material to be added into the second slot according to the second material added into the first slot, the third material may be added into the second slot. Further, a target video may be generated based on the second material, the third material and the video template.

According to the technical scheme of the embodiments of the present disclosure, in response to a video generation operation, when the plurality of slots include a second slot not filled with the second material, a third material to be added into the second slot is determined according to the second material added into the first slot, the third material is added into the second slot, and a target video is generated based on the second material, the third material and the video template. It allows for filling the second slots based on the second materials added in the first slots, while maximizing the retention of the original video effect of the video template. This ultimately enhances the flexibility of the video production process and improves the display effect of the target video.

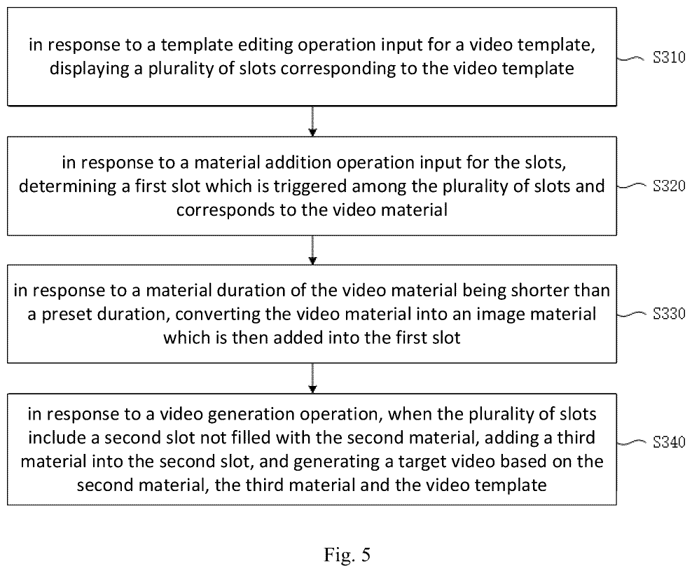

FIG. 5 is a flow diagram of another video processing method according to an embodiment of the present disclosure. In the technical scheme of this embodiment, on the basis of the above embodiment, the second material includes a video material, and a first slot which is triggered among the plurality of slots and corresponds to the video material may be determined; and in response to a material duration of the video material being shorter than a preset duration, the video material is converted into an image material which is then added into the first slot. Detailed implementation can be found in the description of this embodiment. The same or similar technical features as those in the previous embodiments are not repeated here.

As shown in FIG. 5, the method provided by this embodiment may include the following steps.

S310, in response to a template editing operation input for a video template, displaying a plurality of slots corresponding to the video template.

S320, in response to a material addition operation input for the slots, determining a first slot which is triggered among the plurality of slots and corresponds to the video material.

Here, the video material may be understood as a multimedia resource composed of multiple video frames. Alternatively, the video material may be a video pre-stored in a target storage space; or it may be a video obtained in real-time by the user using a recording device; or it may also be a video received from external devices. The first slot corresponding to the video material may be understood as the slot to be filled with the video material. It should be noted that the first slots corresponding to the video material may include all triggered first slots or at least a portion of all triggered first slots, which is not limited by the embodiments of the present disclosure.

In the embodiments of the present disclosure, upon detecting a material addition operation input for the slots, a response to the material addition operation may be initiated. Further, in response to the second material to be added into the slot including a video material, a first slot which is triggered among the plurality of slots and corresponds to the video material may be determined. Subsequently, the video material may be added into the first slot according to predefined material addition logic.

S330, in response to a material duration of the video material being shorter than a preset duration, converting the video material into an image material which is then added into the first slot.

The preset duration may be any length, optionally set to 0.5 seconds, 1 second, or 1.5 seconds, among others. It should be noted that the preset duration may either be a default setting of the application or a user-defined setting, which is not limited by the embodiments of the present disclosure. The image material may be understood as a multimedia resource including a single image.

In the embodiments of the present disclosure, during the process of adding the video material to the first slot, the material duration of the video material may first be compared with the preset duration. Further, in response to the material duration of the video material being shorter than the preset duration, the video material may be taken as a short video material. Subsequently, the video material may be converted into an image material, which is then added to the first slot.

It should be noted that the video material consists of multiple video frames, while the image material consists of a single image. To ensure consistency in content between the image material obtained after conversion and the corresponding video material, any video frame from the video material may be selected as the image material, which is then added to the first slot.

Alternatively, converting the video material into an image material and adding the image material into the first slot includes: acquiring a target video frame of the video material as an image material, and adding the image material into the first slot.

Here, the target video frame may be any video frame from all the video frames included in the video material. Alternatively, the target video frame includes at least one selected from a group consisting of a first video frame, a video frame containing a preset type of image subject and a video frame selected based on a user selection operation.

As an alternative implementation of the embodiments of the present disclosure, in response to the target video frame being the first video frame, the first video frame of the video material may be acquired as the image material, which is then added to the first slot.

As another alternative implementation of the embodiments of the present disclosure, in response to the target video frame being a video frame containing a preset type of image subject, a subject detection algorithm may be applied sequentially to each video frame included in the video material to determine whether the video frame contains the preset type of image subject. Further, the first detected video frame containing the preset type of image subject may be used as the image material, which is then added to the first slot. The preset type of image subject may include users, animals, and user faces, among others.

As another alternative implementation of the embodiments of the present disclosure, in response to the target video frame being a video frame selected based on a user selection operation, if the material duration of the video material is smaller than the preset duration, video frame analysis may be performed on the video material to obtain multiple video frames corresponding to the video material. The multiple video frames may then be displayed on a video frame display page. Further, upon detecting a user selection trigger operation on any of the displayed video frames, the video frame may be used as the target video frame and added as the image material into the first slot.

In the embodiments of the present disclosure, adding a second material into a triggered first slot among the plurality of slots includes: determining a first slot which is triggered among the plurality of slots and corresponds to the video material; in response to the material duration of the video material being longer than or equal to the preset duration and smaller than the slot duration of the corresponding first slot, adding the video material into the first slot; and in response to the material duration of the video material being longer than the slot duration of the first slot, cropping the video material to the slot duration and then adding the video material into the first slot.

As an alternative implementation of the embodiments of the present disclosure, in response to the material duration of the video material being longer than or equal to the preset duration and smaller than the slot duration of the corresponding first slot, the video material may be directly added into the corresponding first slot. In response to the material duration of the video material being longer than the slot duration of its corresponding first slot, the video material may be cropped to ensure that the cropped video material has a duration equal to the slot duration of the corresponding first slot, and the cropped video material may then be added into the corresponding first slot.

S340, in response to a video generation operation, when the plurality of slots include a second slot not filled with the second material, adding a third material into the second slot, and generating a target video based on the second material, the third material and the video template.

According to the technical scheme of the embodiments of the present disclosure, in response to a material addition operation input for the slots, a first slot which is triggered among the plurality of slots and corresponds to the video material is determined. Further, in response to a material duration of the video material being shorter than a preset duration, the video material is converted into an image material which is then added into the first slot. It allows for the conversion of the video material into the image material and slot filling when the video material fails to meet the preset slot criteria, thus improving the display effect of the target video.

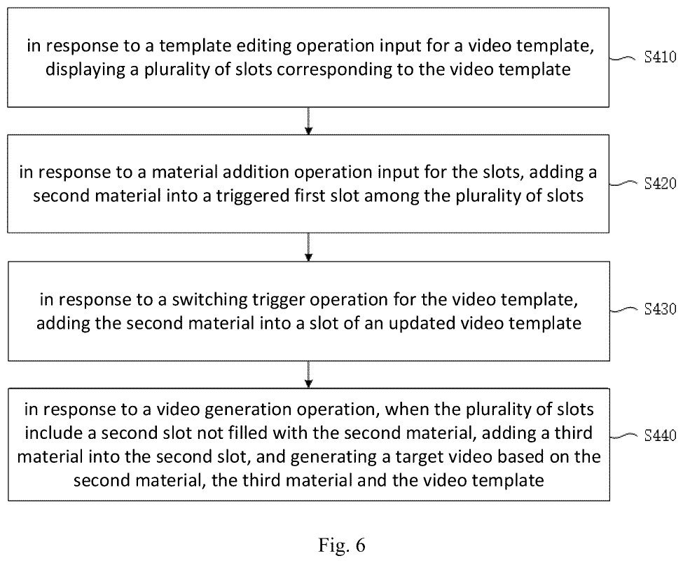

FIG. 6 is a flow diagram of another video processing method according to an embodiment of the present disclosure. In the technical scheme of this embodiment, on the basis of the above embodiment, after adding a second material into a triggered first slot among the plurality of slots, in response to a switching trigger operation for the video template, the second material may be added into a slot of the updated video template. Detailed implementation can be found in the description of this embodiment. The same or similar technical features as those in the previous embodiments are not repeated here.

As shown in FIG. 6, the method provided by this embodiment may include the following steps.

S410, in response to a template editing operation input for a video template, displaying a plurality of slots corresponding to the video template.

S420, in response to a material addition operation input for the slots, adding a second material into a triggered first slot among the plurality of slots.

S430, in response to a switching trigger operation for the video template, adding the second material into a slot of an updated video template.

Here, the switching trigger operation may be understood as an action of switching the currently used video template after being triggered. Alternatively, the switching trigger operation may be implemented by at least one of the following methods: triggering a template switch control; receiving a template switch instruction, etc. The updated video template may be understood as the video template that has been switched to.

In practical applications, during the process of editing and generating the target video based on the video template, if the second material is added to a slot in the video template and the user wants to use another video template for editing, they must exit the editing interface of the current video template and select a new video template. Upon detecting a template editing operation input for the video template, a plurality of slots corresponding to the video template are displayed, but the second material is not added to the displayed slots. In other words, during the process of switching video templates, the selected second material cannot be applied to the updated video template. At this point, if the user wants to compare the preview effects of the two video templates after adding the second material, they need to select the second material again and add it to the slots of the updated video template. This approach to template switching may result in a cumbersome operation process and lower flexibility in switching templates, thereby affecting the user experience with the video templates.

Alternatively, in practical applications, during the process of editing and generating the target video based on the video template, in response to the second material being added into a slot of the video template and a switching trigger operation being input for the video template, it is necessary to first compare the material display information of the added second material with the slot display information of a plurality of slots corresponding to the updated video template. Further, if the comparison result between the material display information and the slot display information fails to meet preset template editing standards, there may be cases where it is not possible to update to a new video template or the updated video template does not include the selected second material.

In view of the above issue, in the embodiments of the present disclosure, upon detecting a switching trigger operation for the video template, the second material may be directly added to the slots of the updated video material based on preset addition logic. The preset addition logic may include sequentially adding the second material according to the arrangement order of the slots in the updated video material, or determining the addition position of the second material in the plurality of slots of the updated video material based on the slot display information of the first slot where the second material was located in the previous video template, among other methods.

S440, in response to a video generation operation, when the plurality of slots include a second slot not filled with the second material, adding a third material into the second slot, and generating a target video based on the second material, the third material and the video template.

In the technical scheme of this embodiment, after adding a second material into a triggered first slot among the plurality of slots, in response to a switching trigger operation for the video template, the second material is added into a slot of the updated video template. This allows for the switching of video templates while retaining the added materials during the process of creating a target video using video templates, thereby enhancing the flexibility and intelligence of the video production process and improving the video production experience for users.

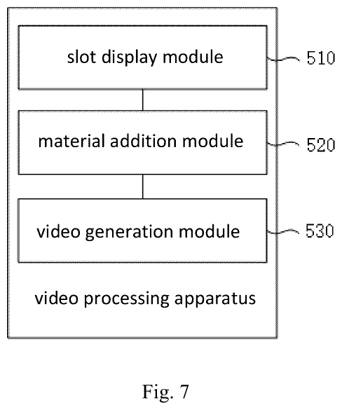

FIG. 7 is a schematic diagram of a video processing apparatus according to an embodiment of the present disclosure. As shown in FIG. 7, the apparatus includes a slot display module 510, a material addition module 520 and a video generation module 530.

Here, the slot display module 510 is configured to, in response to a template editing operation input for a video template, display a plurality of slots corresponding to the video template, the slots corresponding to a first material used for making the video template. The material addition module 520 is configured to, in response to a material addition operation input for the slots, add a second material into a triggered first slot among the plurality of slots. The video generation module 530 is configured to, in response to a video generation operation, when the plurality of slots include a second slot not filled with the second material, add a third material into the second slot, and generate a target video based on the second material, the third material and the video template.

On the basis of the above alternative technical schemes, alternatively, the video generation module 530 includes a material determination unit. Where, the material determination unit is configured to determine a third material to be added into the second slot according to the second material added into the first slot, and add the third material into the second slot.

On the basis of the above alternative technical schemes, alternatively, the material determination unit is specifically configured to determine a third material to be added into each second slot according to arrangement positions of the first slot and the second slot in the plurality of slots and the second material added into the first slot.

On the basis of the above alternative technical schemes, alternatively, the apparatus further includes a slot position adjustment module. Where, the slot position adjustment module is configured to, after responding to the video generation operation and before adding the third material into the second slot, when a plurality of first slots are provided and at least two of the first slots are not continuously arranged, adjust addition positions of the second materials already added into at least one of the first slots in the plurality of slots, to ensure that the plurality of first slots after adjustment are continuously arranged.

On the basis of the above alternative technical schemes, alternatively, a material duration of the second material is shorter than a slot duration of the first slot, and the apparatus further includes a material playback control module. Here, the material playback control module is configured to, after generating a target video based on the second material, the third material and the video template, during the playback of the target video, for the second material with a material duration shorter than a slot duration of the corresponding first slot, control the second material to play in a loop to ensure that a display duration of the second material reaches the slot duration.

On the basis of the above alternative technical schemes, alternatively, the material addition module 520 includes a slot determination unit and a material addition unit. The slot determination unit is configured to determine a first slot which is triggered among the plurality of slots and corresponds to the video material. The material addition unit is configured to, in response to a material duration of the video material being shorter than a preset duration, convert the video material into an image material and adding the image material into the first slot.

On the basis of the above alternative technical schemes, alternatively, the material addition unit is specifically configured to acquire a target video frame of the video material as an image material, and add the image material into the first slot, the target video frame including at least one selected from a group consisting of a first video frame, a video frame containing a preset type of image subject and a video frame selected based on a user selection operation.

On the basis of the above alternative technical schemes, alternatively, the apparatus further includes a template updating module. Here, the template updating module is configured to, after adding a second material into a triggered first slot among the plurality of slots, in response to a switching trigger operation for the video template, add the second material into a slot of an updated video template.

The technical scheme of the embodiments of the present disclosure, by means of the slot display module 510, simplifies the process of editing video templates by responding to a template editing operation input for a video template and displaying a plurality of slots corresponding to the video template. Further, by means of the material addition module 520, in response to a material addition operation input for the slots, a second material is added into a triggered first slot among the plurality of slots, achieving simple replacement of a first material in the video template and enabling easy addition of the customized second material to the video template. Further, by means of the video generation module 530, in response to a video generation operation, when the plurality of slots include a second slot not filled with the second material, a third material is added into the second slot, and a target video is generated based on the second material, the third material, and the video template. This solves the problem of certain limitations in the selection process of video templates during video production in related arts, resulting in a high threshold for the use of video templates. It also enables automatic material filling of unfilled slots in the video template, resulting in the production of a target video based on the video template and the materials already added thereto, thereby reducing the restrictions on the use of video templates. Further, it enhances the flexibility of the video production process, allowing the generated target video to more completely present an effect similar to that of the video template, thereby improving the user experience with the video templates.

The video processing apparatus provided by the embodiments can perform the video processing method provided by any embodiment of the present disclosure, and has corresponding functional modules for executing the method and relevant effects.

It should be noted that the plurality of units and modules included in the apparatus are categorized based on functional logic, but this classification is not restrictive, as long as corresponding functions can be realized. In addition, the names of multiple functional units are only for the convenience of distinguishing each other, and are not used to limit the protection scope of the embodiments of the present disclosure.

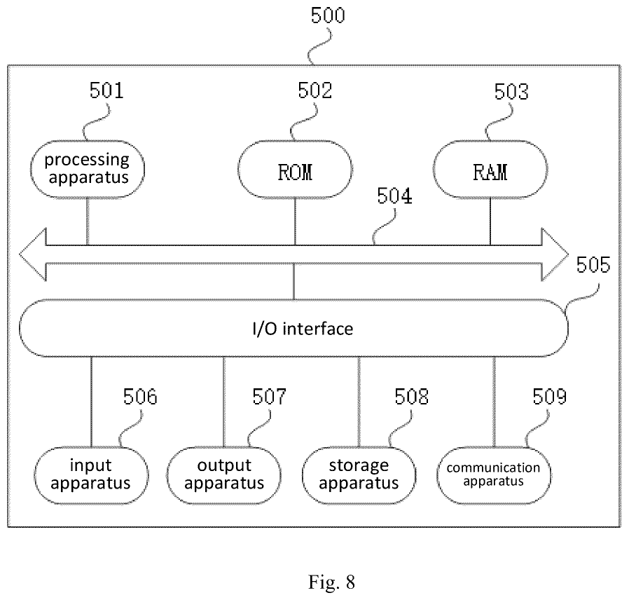

FIG. 8 is a schematic diagram of an electronic device according to an embodiment of the present disclosure. Reference is made to FIG. 8 below, which illustrates a schematic structural diagram of an electronic device (such as the terminal device or server in FIG. 8) 500 suitable for implementing the embodiments of the present disclosure. The terminal device in the embodiments of the present disclosure may include but not be limited to a mobile terminal such as a mobile phone, a notebook computer, a digital broadcast receiver, a personal digital assistant (PDA), a tablet computer (PAD), a portable multimedia player (PMP), a vehicle-mounted terminal (such as vehicle-mounted navigation terminal), and a fixed terminal such as digital a TV, a desktop computer, etc. The electronic device shown in FIG. 8 is only an example, and should not bring any limitation to the functions and scope of use of the embodiments of the present disclosure.

As shown in FIG. 8, the electronic device 500 may include a processing apparatus (e.g., a central processing unit, a graphics processing unit, etc.) 501 that may perform various appropriate actions and processes according to a program stored in a read-only memory (ROM) 502 or a program loaded from a storage apparatus 508 into a random-access memory (RAM) 503. In the RAM 503, various programs and data necessary for the operation of the electronic device 500 are also stored. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, a gyroscope, etc.; an output apparatus 507 including, for example, a liquid crystal display (LCD), a speaker, a vibrator, etc.; the storage apparatus 508 including, for example, a magnetic tape, a hard disk, etc.; and a communication apparatus 509. The communication apparatus 509 may allow the electronic device 500 to perform wireless or wired communication with other devices to exchange data. Although FIG. 8 shows the electronic device 500 having various apparatuses, it should be understood that it is not required to implement or have all of the illustrated apparatuses. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program codes for executing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above functions defined in the method of the embodiments of the present disclosure are executed.

The names of the messages or information exchanged between multiple devices in the embodiments of the present disclosure are for illustrative purposes only and are not intended to limit the scope of these messages or information.

The electronic device provided in the embodiment of the present disclosure belongs to the same inventive concept as the video processing method provided in the above embodiments. Technical details not described in detail in the embodiment may be found in the above embodiments, and the embodiment has the same beneficial effects as the above embodiments.

An embodiment of the present disclosure provides a computer storage medium on which a computer program is stored. When the program is executed by a processor, it implements the video processing method provided in the above embodiments.

It should be noted that the above computer-readable medium in the present disclosure may be a computer-readable signal medium, or a computer-readable storage medium, or any combination of the above two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as part of a carrier wave, and computer-readable program codes are carried therein. This propagated data signal may take many forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or in combination with an instruction execution system, apparatus, or device. The program codes contained on the computer-readable medium may be transmitted by any suitable medium, including but not limited to: a wire, an optical cable, RF (radio frequency), etc., or any suitable combination of the above.

In some implementations, the electronic device may communicate using any currently known or future-developed network protocol, such as HTTP (HyperText Transfer Protocol), and may be interconnected with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future-developed networks.

The above computer-readable medium may be included in the above electronic device; or may exist alone without being assembled into the electronic device.

The above computer-readable medium carries one or more programs that, when executed by the electronic device, cause the electronic device to: in response to a template editing operation input for a video template, display a plurality of slots corresponding to the video template, the slots corresponding to a first material used for making the video template; in response to a material addition operation input for the slots, add a second material into a triggered first slot among the plurality of slots; and in response to a video generation operation, when the plurality of slots include a second slot not filled with the second material, add a third material into the second slot, and generate a target video based on the second material, the third material and the video template.

Computer program codes for performing the operations of the present disclosure may be written in one or more programming languages or a combination thereof. The above programming languages include, but are not limited to, object-oriented programming languages such as Java, Smalltalk, C++, and also include conventional procedural programming languages such as “C” language or similar programming languages. The program codes may be executed entirely on a user's computer, partly on a user's computer, as a stand-alone software package, partly on a user's computer and partly on a remote computer, or entirely on a remote computer or a server. In the case of the remote computer, the remote computer may be connected to the user's computer through any kind of network, including a local area network (LAN) or a wide area network (WAN), or may be connected to an external computer (for example, connected through the Internet using an Internet service provider).

The flowcharts and block diagrams in the drawings illustrate possible architecture, function, and operation implementations of the system, method, and computer program product according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that in some alternative implementations, the functions marked in the blocks may also occur in a different order than the order marked in the drawings. For example, two blocks shown in succession may actually be executed substantially in parallel, or may sometimes be executed in a reverse order, which depends on the functions involved. It should also be noted that each block in the block diagrams and/or flowcharts, and the combination of blocks in the block diagrams and/or flowcharts, may be implemented by a dedicated hardware-based system that performs specified functions or operations, or may be implemented by a combination of dedicated hardware and computer instructions.

The modules involved in the embodiments of the present disclosure may be implemented in software or hardware. The name of a module does not constitute a limitation on the module itself under certain circumstances.

The functions described above in this document may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, the machine-readable medium may be a tangible medium that may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, [Example 1] provides a video processing method including:
in response to a template editing operation input for a video template, displaying a plurality of slots corresponding to the video template, the slots corresponding to a first material used for making the video template;
in response to a material addition operation input for the slots, adding a second material into a triggered first slot among the plurality of slots; and
in response to a video generation operation, when the plurality of slots include a second slot not filled with the second material, adding a third material into the second slot, and generating a target video based on the second material, the third material and the video template.

According to one or more embodiments of the present disclosure, [Example 2] provides the method of Example 1, further including:
Optionally, the adding a third material into the second slot includes: determining a third material to be added into the second slot according to the second material added into the first slot, and adding the third material into the second slot.

According to one or more embodiments of the present disclosure, [Example 3] provides the method of Example 2, further including:
Optionally, the determining a third material to be added into the second slot according to the second material added into the first slot includes: determining a third material to be added into each second slot according to arrangement positions of the first slot and the second slot in the plurality of slots and the second material added into the first slot.

According to one or more embodiments of the present disclosure, [Example 4] provides the method of Example 1, further including:
Optionally, after responding to the video generation operation and before adding the third material into the second slot, further including: when a plurality of first slots are provided and at least two of the first slots are not continuously arranged, adjusting addition positions of the second materials already added into at least one of the first slots in the plurality of slots, the plurality of first slots after adjustment being continuously arranged.

According to one or more embodiments of the present disclosure, [Example 5] provides the method of Example 1, further including:
Optionally, a material duration of the second material is shorter than a slot duration of the first slot; and after generating the target video based on the second material, the third material and the video template, the video processing method further includes: during the playback of the target video, for the second material with the material duration shorter than the slot duration of the corresponding first slot, controlling the second material to play in a loop such that a display duration of the second material reaches the slot duration.

According to one or more embodiments of the present disclosure, [Example 6] provides the method of Example 1, further including:
Optionally, the second material includes a video material; and the adding a second material into a triggered first slot among the plurality of slots includes: determining a first slot which is triggered among the plurality of slots and corresponds to the video material; and in response to a material duration of the video material being shorter than a preset duration, converting the video material into an image material and adding the image material into the first slot.

According to one or more embodiments of the present disclosure, [Example 7] provides the method of Example 6, further including:
Optionally, the converting the video material into an image material and adding the image material into the first slot includes: acquiring a target video frame of the video material as an image material, and adding the image material into the first slot, where the target video frame including at least one selected from a group consisting of a first video frame, a video frame containing a preset type of image subject and a video frame selected based on a user selection operation.

According to one or more embodiments of the present disclosure, [Example 8] provides the method of Example 1, further including:
Optionally, after adding the second material into the triggered first slot among the plurality of slots, further including: in response to a switching trigger operation for the video template, adding the second material into a slot of an updated video template.

According to one or more embodiments of the present disclosure, [Example 9] provides a video processing apparatus, including:
a slot display module configured to, in response to a template editing operation input for a video template, display a plurality of slots corresponding to the video template, the slots corresponding to a first material used for making the video template;
a material addition module configured to, in response to a material addition operation input for the slots, add a second material into a triggered first slot among the plurality of slots; and
a video generation module configured to, in response to a video generation operation, when the plurality of slots include a second slot not filled with the second material, add a third material into the second slot, and generate a target video based on the second material, the third material and the video template.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, but also covers other technical solutions formed by any combination of the above technical features or their equivalent features without departing from the above disclosed concept, for example, a technical solution formed by replacing the above features with technical features with similar functions disclosed in the present disclosure (but not limited to).

In addition, although the operations are described in a particular order, this should not be understood as requiring that the operations be performed in the particular order shown or in a sequential order. Under certain circumstances, multitasking and parallel processing may be advantageous. Likewise, although several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments, either individually or in any suitable sub-combination.

Although the present subject matter has been described in language specific to structural features and/or logical actions of the method, it should be understood that the subject matter defined in the appended claims is not necessarily limited to the specific features or actions described above. Rather, the specific features and actions described above are merely exemplary forms for implementing the claims.

1. A video processing method, comprising:
in response to a template editing operation input for a video template, displaying a plurality of slots corresponding to the video template, the slots corresponding to a first material used for making the video template;
in response to a material addition operation input for the slots, adding a second material into a triggered first slot among the plurality of slots; and
in response to a video generation operation, when the plurality of slots comprise a second slot not filled with the second material, adding a third material into the second slot, and generating a target video based on the second material, the third material and the video template.

2. The video processing method according to claim 1, wherein the adding a third material into the second slot comprises:
determining a third material to be added into the second slot according to the second material added into the first slot, and adding the third material into the second slot.

3. The video processing method according to claim 2, wherein the determining a third material to be added into the second slot according to the second material added into the first slot comprises:
determining a third material to be added into each second slot according to arrangement positions of the first slot and the second slot in the plurality of slots and the second material added into the first slot.

4. The video processing method according to claim 1, after responding to the video generation operation and before adding the third material into the second slot, further comprising:
when a plurality of first slots are provided and at least two of the first slots are not continuously arranged, adjusting addition positions of the second materials already added into at least one of the first slots in the plurality of slots, the plurality of first slots after adjustment being continuously arranged.

5. The video processing method according to claim 1, wherein a material duration of the second material is shorter than a slot duration of the first slot; and after generating the target video based on the second material, the third material and the video template, the video processing method further comprises:
during the playback of the target video, for the second material with the material duration shorter than the slot duration of the corresponding first slot, controlling the second material to play in a loop such that a display duration of the second material reaches the slot duration.

6. The video processing method according to claim 1, wherein the second material comprises a video material; and the adding a second material into a triggered first slot among the plurality of slots comprises:
determining a first slot which is triggered among the plurality of slots and corresponds to the video material; and
in response to a material duration of the video material being shorter than a preset duration, converting the video material into an image material and adding the image material into the first slot.

7. The video processing method according to claim 6, wherein the converting the video material into an image material and adding the image material into the first slot comprises:
acquiring a target video frame of the video material as an image material, and adding the image material into the first slot, wherein the target video frame comprising at least one selected from a group consisting of a first video frame, a video frame containing a preset type of image subject and a video frame selected based on a user selection operation.

8. The video processing method according to claim 1, after adding the second material into the triggered first slot among the plurality of slots, further comprising:
in response to a switching trigger operation for the video template, adding the second material into a slot of an updated video template.

9. An electronic device, comprising:
one or more processors; and
a storage apparatus configured to store one or more programs, wherein
the one or more programs, when executed by the one or more processors, cause the one or more processors to implement a video processing method, wherein the video processing method comprises:
in response to a template editing operation input for a video template, displaying a plurality of slots corresponding to the video template, the slots corresponding to a first material used for making the video template;
in response to a material addition operation input for the slots, adding a second material into a triggered first slot among the plurality of slots; and
in response to a video generation operation, when the plurality of slots comprise a second slot not filled with the second material, adding a third material into the second slot, and generating a target video based on the second material, the third material and the video template.

10. The electronic device according to claim 9, wherein the adding a third material into the second slot comprises:
determining a third material to be added into the second slot according to the second material added into the first slot, and adding the third material into the second slot.

11. The electronic device according to claim 10, wherein the determining a third material to be added into the second slot according to the second material added into the first slot comprises:
determining a third material to be added into each second slot according to arrangement positions of the first slot and the second slot in the plurality of slots and the second material added into the first slot.

12. The electronic device according to claim 9, after responding to the video generation operation and before adding the third material into the second slot, further comprising:
when a plurality of first slots are provided and at least two of the first slots are not continuously arranged, adjusting addition positions of the second materials already added into at least one of the first slots in the plurality of slots, the plurality of first slots after adjustment being continuously arranged.

13. The electronic device according to claim 9, wherein a material duration of the second material is shorter than a slot duration of the first slot; and after generating the target video based on the second material, the third material and the video template, the video processing method further comprises:
during the playback of the target video, for the second material with the material duration shorter than the slot duration of the corresponding first slot, controlling the second material to play in a loop such that a display duration of the second material reaches the slot duration.

14. The electronic device according to claim 9, wherein the second material comprises a video material; and the adding a second material into a triggered first slot among the plurality of slots comprises:
determining a first slot which is triggered among the plurality of slots and corresponds to the video material; and
in response to a material duration of the video material being shorter than a preset duration, converting the video material into an image material and adding the image material into the first slot.

15. The electronic device according to claim 14, wherein the converting the video material into an image material and adding the image material into the first slot comprises:
acquiring a target video frame of the video material as an image material, and adding the image material into the first slot, wherein the target video frame comprising at least one selected from a group consisting of a first video frame, a video frame containing a preset type of image subject and a video frame selected based on a user selection operation.

16. The electronic device according to claim 9, after adding the second material into the triggered first slot among the plurality of slots, further comprising:
in response to a switching trigger operation for the video template, adding the second material into a slot of an updated video template.

17. A storage medium containing computer-executable instructions, wherein the computer-executable instructions, when executed by a computer processor, implement a video processing method, wherein the video processing method comprises:
in response to a template editing operation input for a video template, displaying a plurality of slots corresponding to the video template, the slots corresponding to a first material used for making the video template;
in response to a material addition operation input for the slots, adding a second material into a triggered first slot among the plurality of slots; and
in response to a video generation operation, when the plurality of slots comprise a second slot not filled with the second material, adding a third material into the second slot, and generating a target video based on the second material, the third material and the video template.

18. The storage medium according to claim 17, wherein the adding a third material into the second slot comprises:
determining a third material to be added into the second slot according to the second material added into the first slot, and adding the third material into the second slot.

19. The storage medium according to claim 18, wherein the determining a third material to be added into the second slot according to the second material added into the first slot comprises:
determining a third material to be added into each second slot according to arrangement positions of the first slot and the second slot in the plurality of slots and the second material added into the first slot.

20. The storage medium according to claim 17, after responding to the video generation operation and before adding the third material into the second slot, further comprising:
when a plurality of first slots are provided and at least two of the first slots are not continuously arranged, adjusting addition positions of the second materials already added into at least one of the first slots in the plurality of slots, the plurality of first slots after adjustment being continuously arranged.
